(19) United States
(12) Patent Application Publication
(10) Pub. No.: US 2005/0027225 A1
(43) Pub. Date: Feb. 3, 2005

(54) Continous wrist distraction unit

(76) Inventor: David A. Bohn, Ridgeley, WV (US)

Correspondence Address: ROTHWELL, FIGG, ERNST & MANBECK, P.C., 1425 K STREET, N.W., SUITE 800, WASHINGTON, DC, 20005, US

(21) Appl. No.: 10/811,146

(22) Filed: Mar. 29, 2004

Related U.S. Application Data
(60) Provisional application No. 60/457,881, filed on Mar. 27, 2003.

(51) Int. Cl. G04B 47/00

(52) U.S. Cl. 602/32

(57) ABSTRACT

A wrist, arm and/or hand traction system is disclosed that has a chair for a patient to sit upon; an elbow strap for retaining an elbow region of the patient's arm; a wrist strap for retaining a wrist region of the patient's arm; a static traction device for applying a static, non-intermittent traction force upon said wrist strap.

Priority is claimed to U.S. Provisional Application Ser. No. 60/457,881 filed on Mar. 27, 2003, the entire disclosure of which is incorporated herein by reference

### BACKGROUND OF THE INVENTION

1. Field of the Invention

The present invention relates generally to therapeutic traction devices and certain preferred embodiments relate, more particularly, to the application of traction forces to the carpal bones of an individual is wrist.

2. Backround Discussion

The present discussion reflects the inventor's knowledge of the art and problems therein and does not constitute an admission of knowledge in the prior art, such as, for example, related to knowledge of problems in the prior art.

Over the last decade, carpal tunnel syndrome (CTS) has reached substantially epidemic proportions in the workplace with the increased use of the computers (e.g., mouse-use and/or keyboard-use). CTS usually affects workers whose duties subject them to repetitive or awkward hand motions. Treatment often consists of surgical intervention to decompress the median nerve in the carpal tunnel.

CTS is often a painful nerve problem that limits the use of an individual's hand, arising when pressure is exerted on the median nerve, which runs from one's neck through one's wrist to the thumb and first three fingers of the hand. The name for the disease or syndrome is derived from the location of one's pain sensations, the carpal tunnel, which is a narrow, rigid opening that is formed by bones and ligiments. Sliding through this tunnel are the tendons that control movements of one's fingers, and the median nerve, carrying one's brain's messages to the spinal cord and then to one's hand.

CTS is classified as a Repetitive Stress Injury (RSI) because it is most frequently caused by repetitive motion. Often, the tendons traveling through the carpal tunnel become aggravated by friction. Symptoms can include, e.g., numbness, burning and/or tingling. Severe CTS can also produce a shooting pain in the wrist and/or forearm. CTS often affects the strength of one's grip.

While surgery may give some relief, research studies have shown that surgeries for CTS may only have about a 40 percent to 70 percent success rate. Moreover, for some patients, the surgery has to be repeated. In most cases, recovery is far below the 100 percent mark. This poor record for surgery is typically not the surgeon's fault. In many cases, surgery may not correct the underlying cause and, therefore, may only provide partial, temporary and/or limited relief.

Health care practitioners who treat CTS often find that certain awkward and/or repetitive hand movements that are considered as causes for the condition may, in fact, only have been responsible for aggravating a previous injury.

Many CTS patients report previous wrist injuries, which often resulted many years ago. Examination frequently reveals slight misalignments of the wrist bones, often due to past injuries. In many instances, lack of treatment allowed such misalignments to become chronic. Often, this type of scenario sets the stage for joint derangements that can blossom into full blown carpal tunnel syndrome. This syndrome may occur, for example, weeks, months or years later. Often, the syndrome occurs at a time when the hand or wrist is subjected to repetitive motion.

The above helps to illustrate why some workers may do the same task, while one worker develops CTS and the other worker remains pain free.

While a variety of traction devices are known, there remains a need for a wrist, arm and/or hand traction system that can overcome, among other things, the above and/or other problems.

### SUMMARY OF THE PREFERRED EMBODIMENTS

Various embodiments of the present invention can significantly improve upon existing systems and methods. In some preferred embodiments of the present invention, one or more of the above and/or other problems can be overcome.

Preferred embodiments can provide for quick and/or effective treatment of an individual's wrist, arm and/or hand without, wrist, arm and/or hand numbness, pain and/or tingling.

According to one illustrative embodiment, a wrist, arm and/or hand traction system is provided that includes: a) a chair for a patient to sit upon; b) an elbow strap for retaining an elbow region of the patient's arm; c) a wrist strap for retaining a wrist region of the patient's arm; d) a static traction device for applying a static, non-intermittent traction force upon said wrist strap. Preferably, the static traction device includes a rope and a locking device for retaining the rope at a desired position, and, more preferably, at least one pulley over which said rope passes and a handle for an operator to pull said rope to achieve a desired traction. In some preferred embodiments, the system can be used to treat CTS by: placing a patient upon said device; using said device to apply traction to at least one of the patient's wrists, arms and/or hands.

The above and/or other aspects, features and/or advantages of various embodiments will be further appreciated in view of the following description in conjunction with the accompanying figures. Various embodiments can include and/or exclude different aspects, features and/or advantages. In addition, various embodiments can combine one or more aspect or feature from other embodiments. The descriptions of aspects, features and/or advantages of particular embodiments should not be construed as limiting other embodiments or the claims.

### BRIEF DESCRIPTION OF THE DRAWINGS

The accompanying figures are provided by way of example, without limiting the broad scope of the invention or various other embodiments. In the figures, like reference numerals designate like or similar parts, wherein:

FIG. 1 is a front view of a device according to one illustrative embodiment of the invention with an individual seated and strapped thereto;

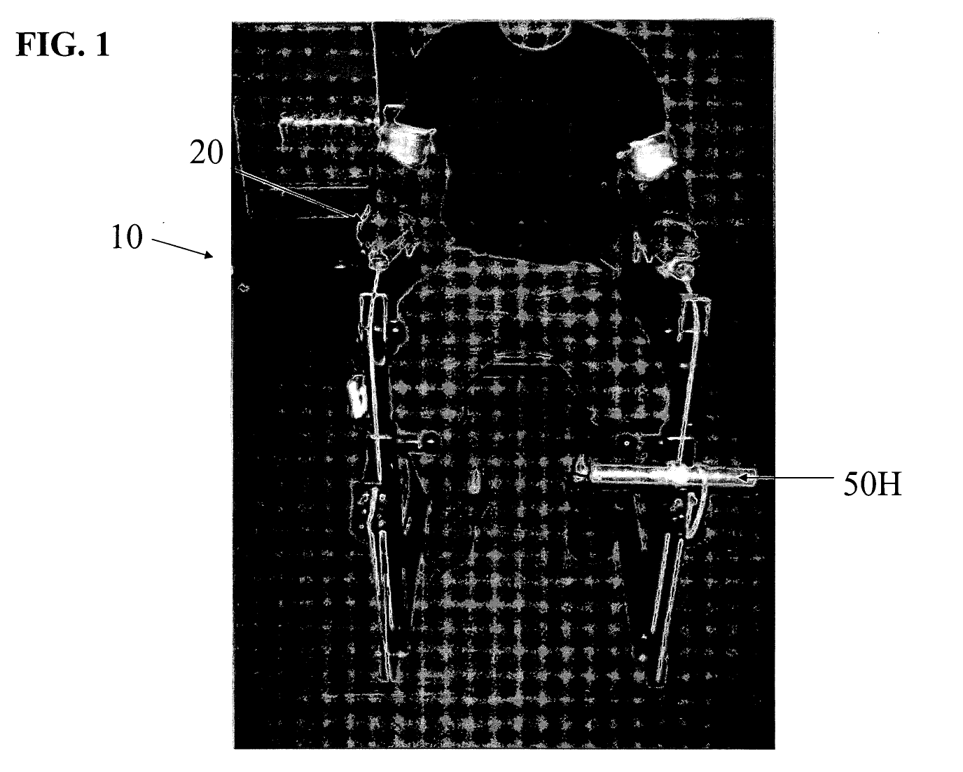

FIG. 2 is a side elevational view of the device shown in FIG. 1;

FIG. 3 is a side elevational view of the device shown in FIG. 1 with an individual seated and strapped thereto; and

FIG. 4 is a rear elevational view of the device shown in FIG. 1 with an individual seated and strapped thereto.

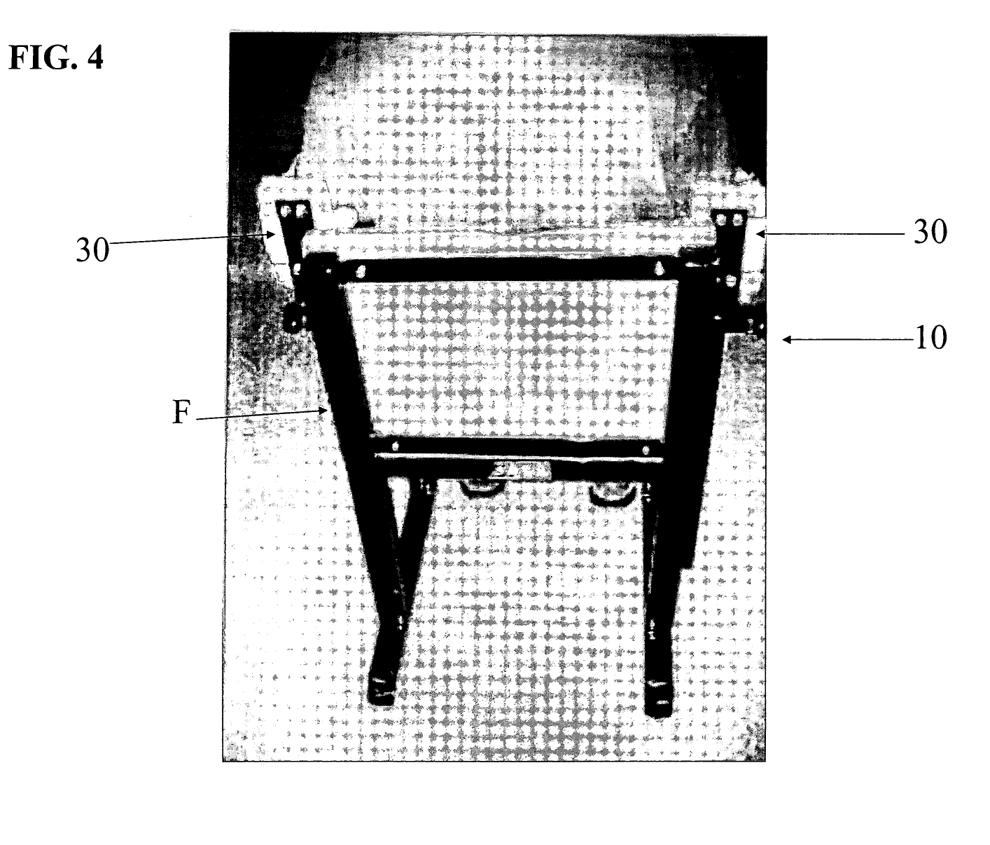

### DETAILED DESCRIPTION OF CERTAIN PREFERRED EMBODIMENTS

Chiropractors, physiatrists, osteopaths and the like doctors, and other therapists, have long used manipulation for treating neck, shoulder, arm and/or hand complaints. Often, these treatments have good results. However, existing systems have had some limitations.

With the continuous wrist traction unit of the preferred embodiments of the invention, chiropractic doctors, physical & occupational therapists, certified hand therapists and medical physicians and the like now have an additional option in the treatment of carpal tunnel syndrome and related problems and/or other arm, wrist and/or hand problems, such as pain and/or numbness.

In the preferred embodiments, a continuous wrist traction unit 10 is provided that uses continuous (e.g., constant), non-motorized traction to stretch the wrist joint, the muscles, the ligaments, the tendons and/or the fasciae in an individual's forearm, which are typically tightened in CTS victims.

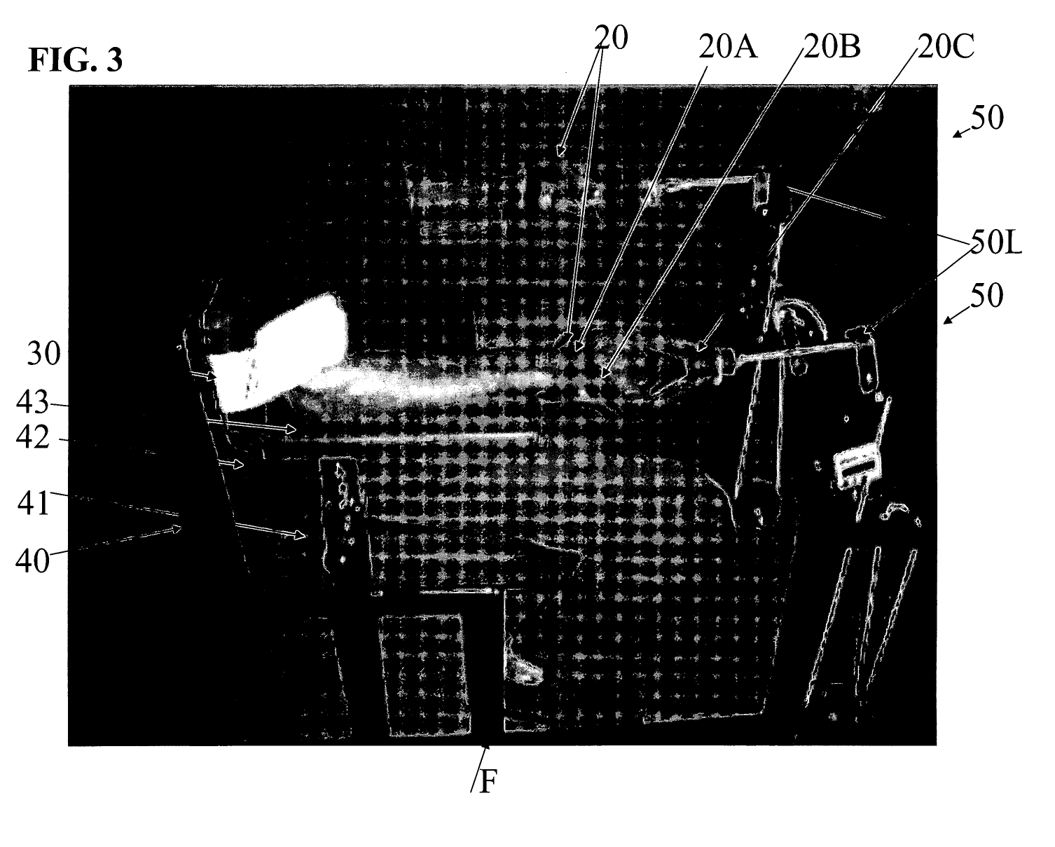

In preferred embodiments, a wrist strap 20 is provided that supports a users wrist. Preferably, the wrist strap 20 includes two straps 20A depending from sides of a grip unit 20B. Preferably, the grip unit 20B is substantially triangular and substantially rigid. Preferably, one leg of the triangular grip unit 20B is adapted to fit across a user's palm (e.g., a few inches long) and is rounded or contoured for gripping. Preferably, the straps 20A depend from sides of the said one leg. Preferably, the straps 20A can wrap around a user's wrist (e.g. as shown in FIG. 3) and connect together (such as, e.g., using hook and loop fastening fabric). Preferably, an elbow and arm strap 30 is also provided. Preferably, with this preferred wrist strap structure, a patient is able to tolerate static traction at an intensity and for a treatment time sufficient to cause a plastic deformation or other deformation of the associated soft tissues of the wrist, allowing for reduction of the inflammation, pain and/or weakness that are often associated with carpal tunnel syndrome.

In the preferred embodiments, the apparatus can be used to exert a controlled static and continuous traction force to the arm and wrist. Preferably, the device can, thus, relax the muscles and/or ligaments that may cause compression of the median nerve in the wrist. Preferably, a continuous stretching allows the carpal bones to open and, thus, allows more room in the carpal tunnel as a result of the carpal ligament relaxation.

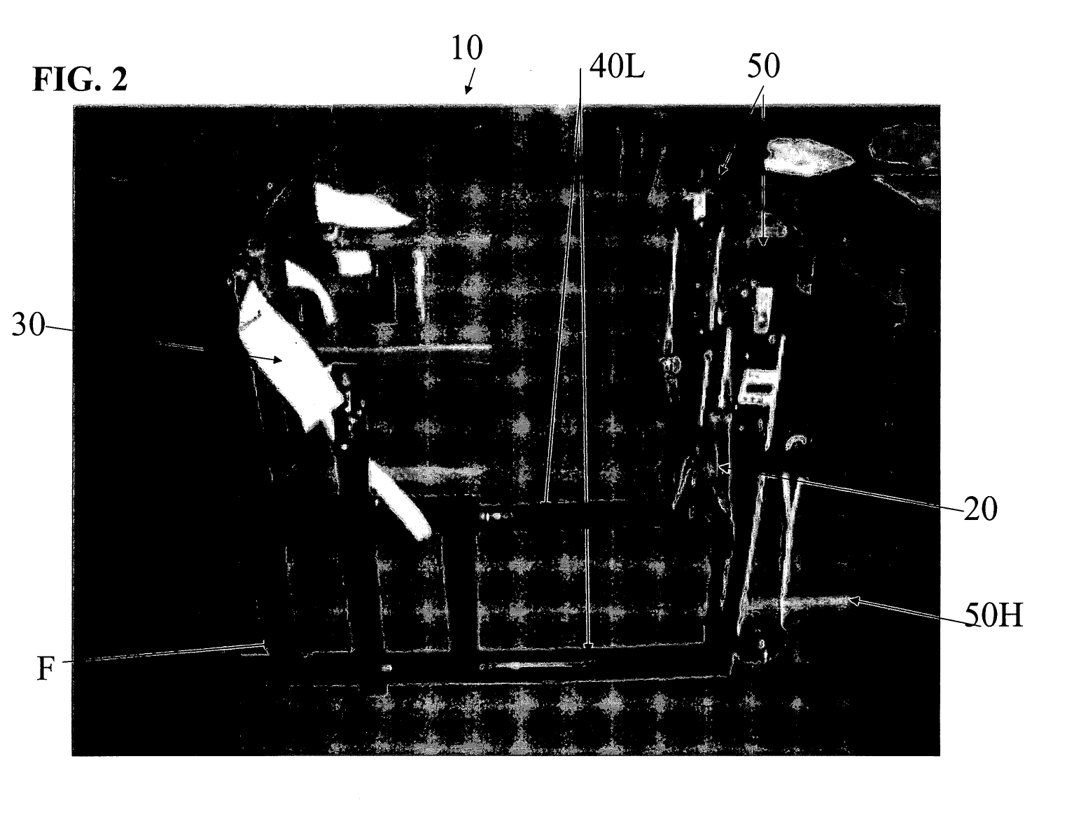

In some preferred embodiments, the device includes a chair 40 having a seat 41 upon which an individual sits, a backrest 42 against which an individual's back rests, and two armrests 43 upon which a user's arms rest. Preferably, the armrests 43 are vertically adjustable (such as, e.g., via a telescoping support bar as shown in FIGS. 2-3).

Preferably, the system includes two laterally extendable support bars 40L that enable the unit to be adjusted in a generally horizontal direction (such as, by providing the bars 40L with telescoping sections to adjust the length).

In preferred embodiments, the system 10 includes a chair 40, support bars 40L and at least one wrist puller(s) 50. In some illustrative embodiments, two wrist pullers 50 are provided. In preferred embodiments, each wrist puller 50 includes an upright support beam, a first pulley rotatably mounted proximate the top of the support beam, a second pulley rotatably mounted proximate a lower region of the support beam, a rope or the like extending from the member 20B over the first pulley, under the second pulley and terminating at a handle 50H. Preferably, each puller 50 also includes a lock 50L to lock the rope at a particular position. The lock 50L can include, for instance, a bar or the like mechanism that is moved into a position to press against the rope to retain the rope at a particular position (such as, e.g., via a camming action against the rope).

Preferably, the system is constructed as a single unit, such as including a single frame F, such as in the embodiment shown. In some illustrative embodiments, the frame can be made of metal and/or another strong, rigid material.

In the preferred embodiments, a continuous wrist distraction unit can be used to achieve an outstanding success rate without surgery, even in advanced cases of carpal tunnel syndrome.

In illustrative embodiments, the system can operate as follows. First a patient may be seated on the unit. Then, the unit may be adjusted to accommodate the individual (such as, e.g., adjusting armrest position and/or length 40L). Then, the individual's elbows can be strapped in place using the straps 30. Then, a wrist strap 20 can be strapped onto the individual so as to be in a position similar to that shown in FIG. 3. At this point, the patient can be positioned with substantially no tension upon the patient's arms.

Then, a device operator (such as, e.g., a doctor, therapist or other medical practitioner) can pull on a first handle 50H while observing the respective wrist of the patient. Upon achieving a desired traction, the device operator can then lock the rope in position using the lock 50L. For instance, upon observing the wrist stretch and/or movement to a particular degree, the device operator can lock the rope in position. The operator can then proceed to the second wrist and perform the same operation (if desired).

In some preferred embodiments, the operator can stand substantially in front of the patient, while facing the patient to operate the device. The handle 50H can be easily manipulated by a gentle upward pulling force to increase tension. This provides an easy to use system for the operator. The handle 50 can alternatively have other handle structures, such as rings, knobs or the like.

In preferred embodiments, the system 10 can advantageously apply a traction to one's wrist without the use of motors. However, in some less preferred embodiments, motors could be used to effect tension via the rope.

In preferred embodiments, which the rope is locked, the patient's arm is subject to tension without applying a weighted force. That is, the system preferably locks the rope in position, so as to create a static tension. Preferably, the system can be used to apply substantially continuous, non-intermittent traction for a period of time (such as, e.g. a few minutes or more).

In some illustrative embodiments, the rope is preferably substantially non-stretchable. In some embodiments, the rope can be a nylon chord. In some embodiments, the rope can include a chain or the like. In some embodiments, the rope can include some degree of stretchability and/or a spring mechanism or the like can be included to allow the rope to stretch to some degree.

While illustrative embodiments of the invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure or step are not recited.

1. A wrist, arm and/or hand traction system, comprising:
a) a chair for a patient to sit upon;
b) an elbow strap for retaining an elbow region of the patient's arm;
c) a wrist strap for retaining a wrist region of the patient's arm;
d) a static traction device for applying a static, non-intermittent traction force upon said wrist strap.

2. The system of claim 1, wherein said static traction device includes a rope and a locking device for retaining the rope at a desired position.

3. The system of claim 2, wherein said static traction device includes at least one pulley over which said rope passes and a handle for an operator to pull said rope to achieve a desired traction.

4. A method of using the system of claim 1 to treat CTS, comprising: placing a patient upon said device; using said device to apply traction to at least one of the patient's wrists, arms and/or hands.
